(19) United States
(12) Patent Application Publication
(10) Pub. No.: US 2014/0070934 A1
(43) Pub. Date: Mar. 13, 2014

(54) METHODS AND SYSTEMS FOR MONITORING DRIVER OBJECT DETECTION

(71) Applicants: JARVIS CHAU, TORONTO (CA); MARK A. MANICKARAJ, TORONTO (CA); NORMAN J. WEIGERT, TORONTO (CA)

(72) Inventors: JARVIS CHAU, TORONTO (CA); MARK A. MANICKARAJ, TORONTO (CA); NORMAN J. WEIGERT, TORONTO (CA)

(73) Assignee: GM GLOBAL TECHNOLOGY OPERATIONS LLC, DETROIT, MI (US)

(21) Appl. No.: 13/607,232

(22) Filed: Sep. 7, 2012

(51) Int. Cl. B60K 37/00

(52) U.S. Cl. CPC B60K 37/00
USPC 340/438

(57) ABSTRACT

Methods and systems are provided for detecting whether a driver of a vehicle detected an object outside of the vehicle. In one embodiment, the method includes: receiving external sensor data that indicates a scene outside of the vehicle; receiving internal sensor data that indicates an image of the driver; determining whether the driver detected the object based on the external sensor data and the internal sensor data; and selectively generating a control signal based on whether the driver detected the object.

### TECHNICAL FIELD

The technical field generally relates to methods and systems for monitoring driver object detection, and more particularly relates to methods and systems for monitoring driver object detection using stereo vision and gaze detection and warning a driver using a heads-up display.

### BACKGROUND

In an attempt to enhance safety features for automobiles, heads up displays (HUD) are being incorporated into vehicles. A heads up display projects a virtual image onto the windshield. The image presented to the driver includes information pertaining to the vehicle's status, such as speed. This allows the driver to easily view the information while still looking out through the windshield. Thus allowing the driver to maintain their heads up position while driving instead of breaking their view of the road to determine the information.

In some cases, the driver's view of the road may still be temporarily distracted. For example, when adjusting a setting of the infotainment system, the driver may temporarily look away from the road to view the infotainment system. Accordingly, it is desirable to present warning information to the driver using the heads up display. In addition, it is desirable to provide the warning information in a manner that attracts the driver's attention back to the road when the driver is distracted. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for detecting whether a driver of a vehicle detected an object outside of the vehicle. In one embodiment, a method includes: receiving external sensor data that indicates a scene outside of the vehicle; receiving internal sensor data that indicates an image of the driver; determining whether the driver detected the object based on the external sensor data and the internal sensor data; and selectively generating a control signal based on whether the driver detected the object.

In one embodiment, the system includes a first module that receives external sensor data that indicates a scene outside of the vehicle. A second module receives internal sensor data that indicates an image of the driver. A third module determines whether the driver detected the object based on the external sensor data and the internal sensor data. A fourth module selectively generates a control signal based on whether the driver detected the object.

In one embodiment, a vehicle includes a heads up display system, and a heads up display control module. The heads up display control module receives external sensor data that indicates a scene outside of the vehicle, receives internal sensor data that indicates an image of the driver, determines whether the driver detected the object based on the external sensor data and the internal sensor data, and selectively generates a control signal to the heads up display system based on whether the driver detected the object.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes a driver object detection system in accordance with various embodiments;

FIG. 2 is a dataflow diagram illustrating a driver object detection system in accordance with various embodiments; and

FIG. 3 is a flowchart illustrating a driver object detection method that may be performed by a driver object detection system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

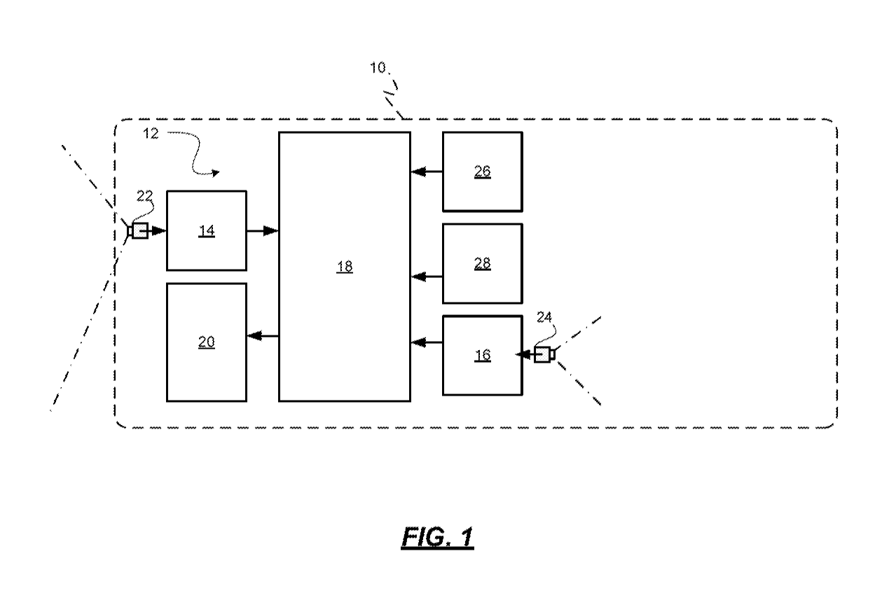

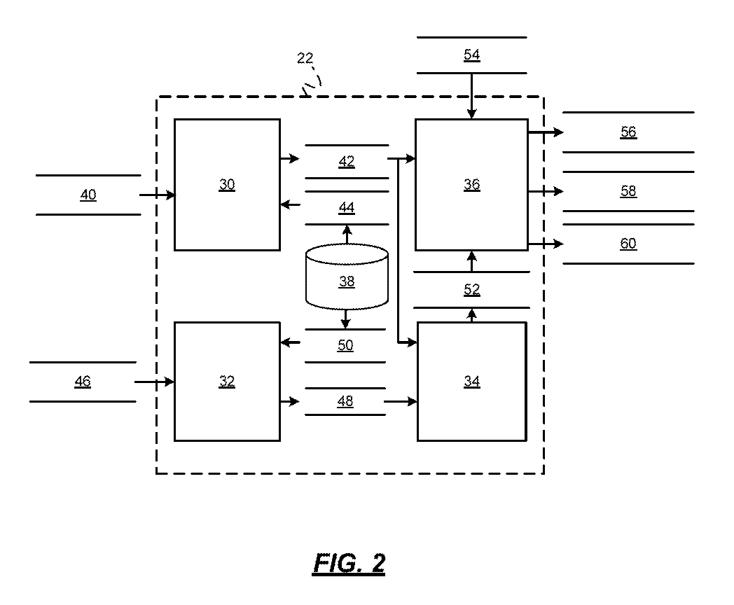

Referring now to FIG. 1, a vehicle 10 is shown to include a driver object detection system 12 in accordance with various embodiments. Although the figures shown herein depict an example with certain arrangements of elements, additional intervening elements, devices, features, or components may be present in an actual embodiments. It should also be understood that FIG. 1 is merely illustrative and may not be drawn to scale.

In various embodiments, the driver object detection system 12 includes an external sensor system 14, an internal sensor system 16, a heads up display (HUD) control module 18, and a HUD system 20. The external sensor system 14 communicates with a sensor device 22 that includes one or more sensors that sense observable conditions in proximity to or in front of the vehicle 10. The sensors can be image sensors, radar sensors, ultrasound sensors, or other sensors that sense observable conditions in proximity to the vehicle 10. For exemplary purposes, the disclosure is discussed in the context of the sensor device 22 including at least one image sensor or camera that tracks visual images in front of the vehicle 10. The image device senses the images and generates sensor signals based thereon. The external sensor system 14 processes the sensor signals and generates external sensor data based thereon.

The internal sensor system 16 communicates with a sensor device 24 that includes one or more sensors that sense observable conditions of a driver within the vehicle 10. For exemplary purposes, the disclosure is discussed in the context of the sensor device 24 including at least one image sensor or camera that tracks visual images of the driver of the vehicle 10. The image device senses the images and generates sensor signals based thereon. The internal sensor system 16 processes the sensor signals and generates internal sensor data based thereon.

The HUD control module 18 receives the data generated by the internal sensor system 16 and the external sensor system 14 and processes the data to determine if an object (e.g., person, traffic sign, etc.) is in proximity to the vehicle 10 and to determine if the driver has detected and looked at the object in proximity to the vehicle 10. If the driver has not detected the object, the HUD control module 18 selectively generates signals to the HUD system 20 such that a display of the HUD system 20 displays an image that highlights the object to the driver. The HUD system 20 displays a non-persistent highlight of the object to replicate the object graphically on a windshield (not shown) of the vehicle 10. The HUD system 20 displays the highlight in a location on the windshield where a driver would see the object if the driver were looking in the right direction.

In various embodiments, the HUD control module 18 selectively generates the control signals such that the highlight indicates a threat status of the object to the driver. For example, when the object poses an imminent threat of collision, the highlight may be displayed according to first display criteria; when the object poses an intermediate threat of collision, the highlight may be displayed according to second display criteria; and so on. The HUD control module 18 generates the control signals to display the highlight until it is determined that the driver has seen and acknowledged the object. Once it is determined that the driver has acknowledged the object, the HUD control module 18 can dim or remove the highlight.

In various embodiments, the HUD control module 18 coordinates with warning systems 26 (e.g., audible warning systems, haptic warning systems, etc.) to further alert the driver of the object when the driver has not detected the object. In various embodiments, the HUD control module 18 coordinates with collision avoidance systems 28 (e.g., braking systems) to avoid collision with the object when the driver has not detected the object.

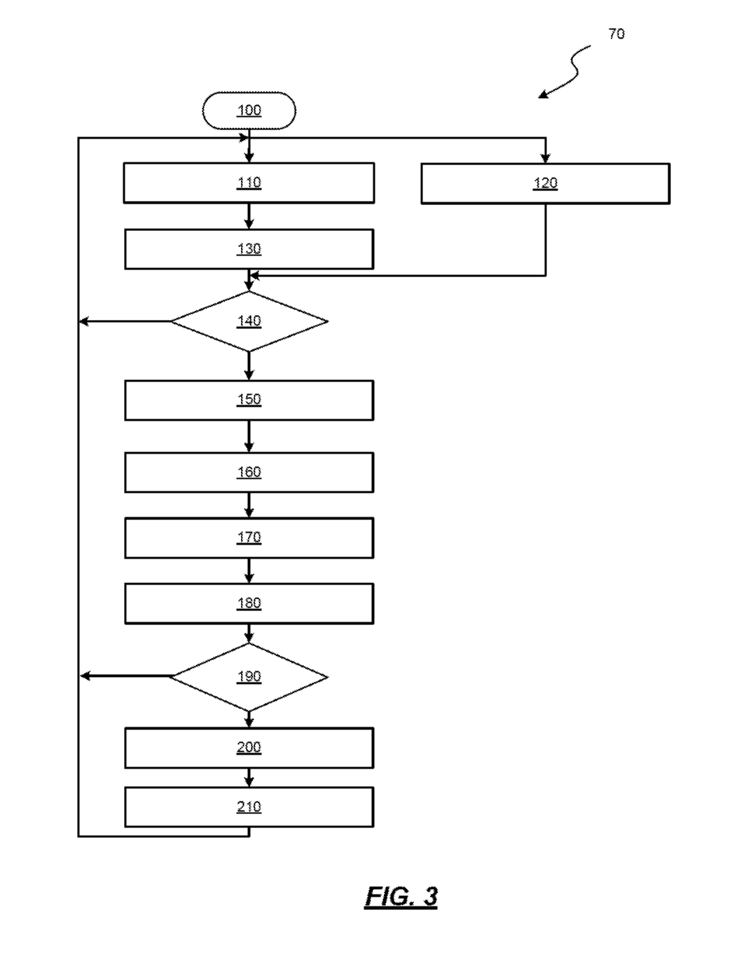

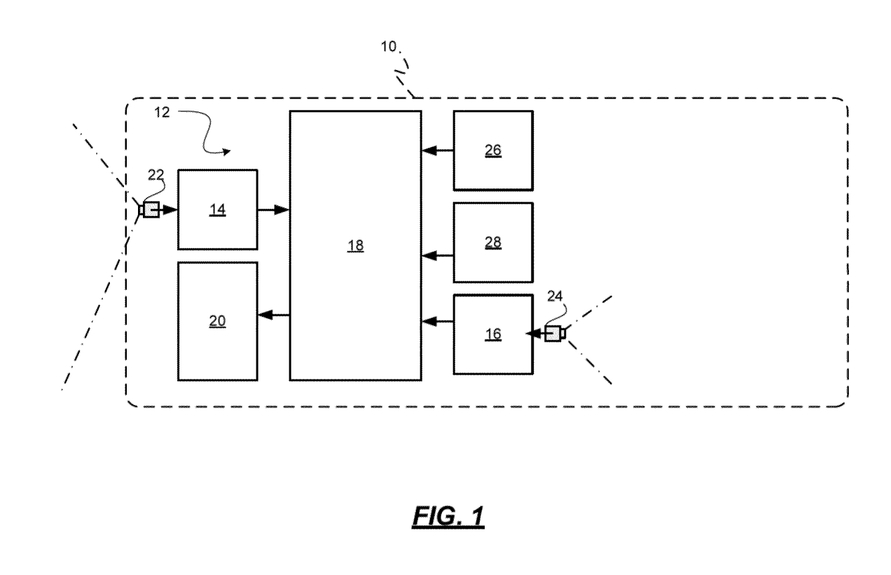

Referring now to FIG. 2, a dataflow diagram illustrates various embodiments of HUD control module 18 of the driver object detection system 12. Various embodiments of the HUD control module 18 according to the present disclosure may include any number of modules or sub-modules. As can be appreciated, the modules shown in FIG. 2 may be combined into a signal module and/or further partitioned to multiple modules to similarly determine a driver's detection of an object and alert the driver using the HUD system 20. Inputs to the HUD control module 18 may be received from the sensor systems 14, 16 of the vehicle 10 (FIG. 1), received from other modules (not shown) of the vehicle 10 (FIG. 1), and/or determined by other sub-modules (not shown) of the HUD control module 18. In various embodiments, the HUD control module 18 includes an external data monitoring module 30, an internal data monitoring module 32, a driver object detection analysis module 34, a HUD display module 36, and a HUD map datastore 38.

The external data monitoring module 30 receives as input external sensor data 40. Based on the external sensor data 40, the external data monitoring module 30 detects whether an object is in front of and in a path that the vehicle 10 is traveling. When an object is detect, the external data monitoring module maps the coordinates of the object represented in the external sensor data 40 to coordinates of a display (i.e., the windshield) of the HUD system 20, and generates the object map 42 based thereon.

For example, the external sensor data 40 represents a scene in front of the vehicle 10. The scene is represented in a two dimensional (x, y) coordinate system. The external data monitoring module 30 associates each x, y coordinate of the object with an x′, y′ coordinate of the display using a HUD map 44. The external data monitoring module 30 then stores data associated with the x, y coordinates of the object in the x′, y′ coordinates of the object map 42. For example, a positive value or one value is stored in each coordinate in which the object is determined to be; and a negative or zero value is stored in each coordinate in which the object is determined not to be. In various embodiments, the HUD map 44 may be a lookup table that is accessed by the x, y coordinates of the scene and that produces the x′, y′ coordinates of the display. In various embodiments, the HUD map 44 is predetermined and stored in the HUD map datastore 38.

The internal data monitoring module 32 receives as input internal sensor data 46. In various embodiments, the internal sensor data represents images of the driver (e.g., the head and face) of the vehicle 10. The internal data monitoring module 32 evaluates the internal sensor data 46 to determine a gaze (e.g., an eye gaze and/or a head direction) of the driver. As can be appreciated, various methods may be used to determine the gaze of the driver. For example, methods such as those discussed in [inventors: is there a general method discussing how to determine driver gaze or can we reference a patent?] which are incorporated herein by reference in their entirety, or other methods may be used to detect the gaze of the driver.

The driver gaze is represented in a two dimensional (x, y) coordinate system. The internal data monitoring module 32 maps the coordinates of the driver gaze to coordinates of the display and generates a gaze map 48 based thereon.

For example, the internal data monitoring module 32 associates each x, y coordinate of the driver gaze with an x′, y′ coordinate of the display using a HUD map 50. The internal data monitoring module 32 then stores data associated with the x, y coordinates of the driver gaze in the x′, y′ coordinate of the gaze map 48. For example, a positive value or one value is stored in each coordinate in which the driver is determined to be gazing; and a negative or zero value is stored in each coordinate in which the driver is determined to not be gazing. In various embodiments, the HUD map 50 may be a lookup table that is accessed by the x, y coordinates of the driver gaze and that produces the x′, y′ coordinates of the display. In various embodiments, the HUD map 50 is predetermined and stored in the HUD map datastore 38.

The driver object detection analysis module 34 receives as input the object map 42, and the gaze map 48. The driver object detection analysis module 34 evaluates the object map 42 and the gaze map 48 to determine if the driver is looking at or in the direction of the detected object. The driver object detection analysis module 34 sets an object detection status 52 based on whether the driver is not looking at the detected object, or whether the driver is looking at and has recognized the detected object. For example, if no coordinates having positive data of the gaze map 48 overlap with coordinates having positive data of the object map 42, then the driver is not looking at the detected object, and the driver object detection analysis module 34 sets the object detection status 52 to indicate that the driver has not looked at the object. If some (e.g., between a first range or within a first percentage of the coordinates) or all of the coordinates having positive data of the gaze map 48 overlap with coordinates having positive data of the object map 42, the driver is looking at the detected object and the driver object detection analysis modules 34 sets the object detection status 52 to indicate that the driver is looking at the detected object.

The HUD display module 36 receives as input the driver object detection status 52 and optionally a threat status 54. Based on the driver object detection status 52, the HUD display module 36 generates HUD control signals 56 to selectively highlight images on the display of the HUD system 20. For example, if the object detection status 52 indicates that the driver did look at the object, the object is not highlighted on the display. If the object detection status 52 indicates that the driver did not look at the object, the HUD controls signals 56 are generated to highlight the object on the display. The HUD display module 36 generates the HUD control signals 56 to highlight the object at a location indicated by the object map 42.

In various embodiments, the object can be selectively highlighted based on the object's threat status 54 as indicated by the objects distance from the vehicle 10 and/or an estimated time to collision with the object. For example, at least two colors can be utilized, where one color is used to highlight objects far enough away that the time to collision is deemed safe (e.g., an intermediate threat), and another color is used to highlight objects that are close enough that the time to collision is deemed unsafe (e.g., and imminent threat). In various embodiments, the color from one state to another can fade from one to the other, hence allowing more colors. As can be appreciated, more colors may be implemented for systems having more threat levels.

In another example, at least two display frequencies can be utilized, where one display frequency (e.g., a higher frequency) is used to flash the highlight when the object is deemed a first threat status (e.g., an imminent threat status), and a second display frequency (e.g., a lower frequency) is used to flash the highlight when the object is deemed a second threat status (e.g., an intermediate threat status). In various embodiments, the frequency from one state to another can blend, hence allowing more frequencies. As can be appreciated, more frequencies may be implemented for systems having more threat levels.

In various embodiments, the HUD display module 36 may further coordinate with the other warning systems 26 and/or the collision avoidance systems 28 when the object detection status 52 indicates that the driver did not look at the object. For example, warning signals 58 may be selectively generated to the warning systems 26 such that audible warnings may generated in time with the highlight or after a period of time that the highlight has been displayed. In another example, control signals 60 may be selectively generated to the collision avoidance systems 28 such that braking or other collision avoidance techniques may be activated in time with the highlight or after a certain period of time that the highlight has been displayed.

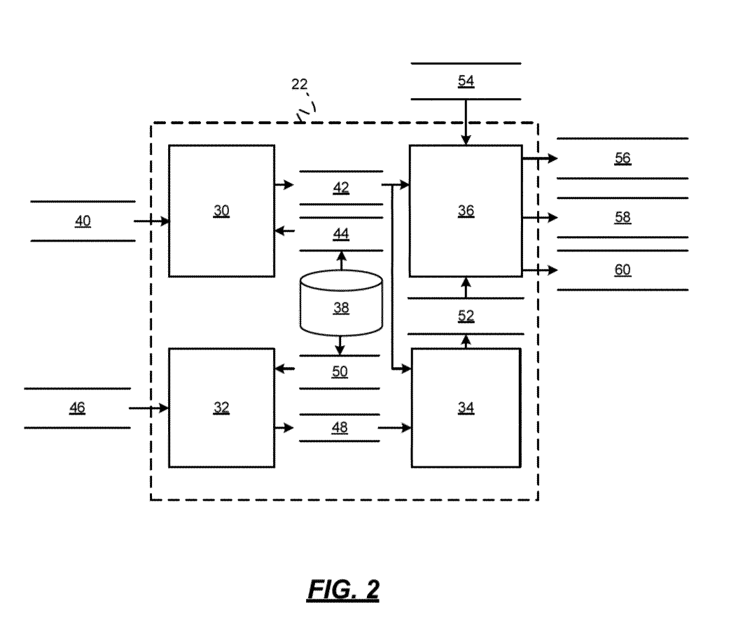

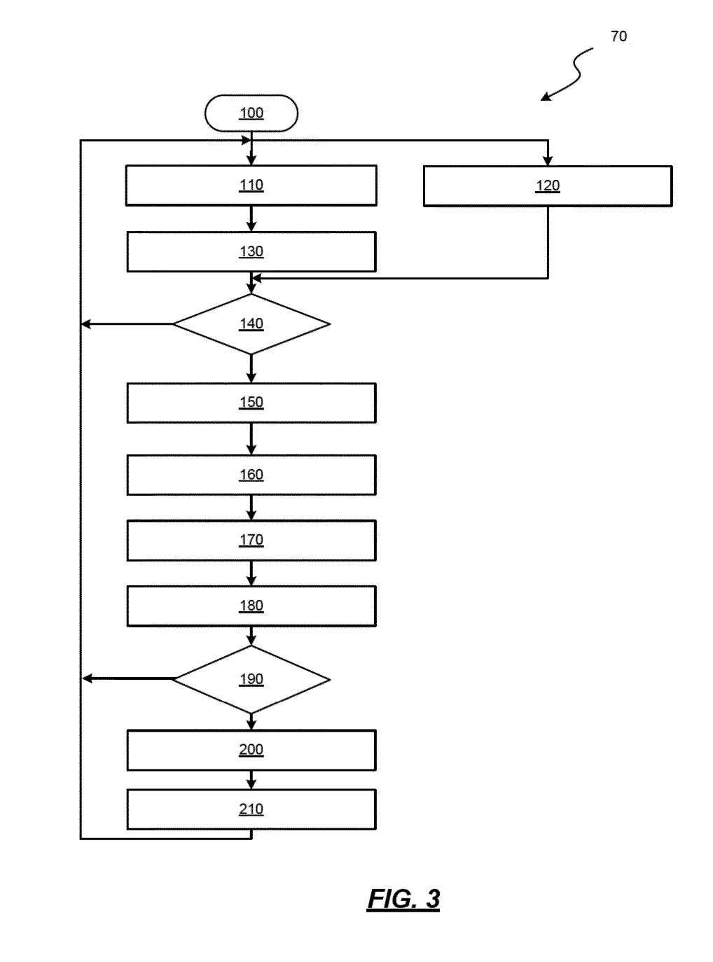

Referring now to FIG. 3, and with continued reference to FIGS. 1 and 2, a flowchart illustrates a driver object detection method 70 that can be performed by the driver object detection system 12 of FIG. 1 in accordance with various embodiments. As can be appreciated in light of the disclosure, the order of operation within the method is not limited to the sequential execution as illustrated in FIG. 3, but may be performed in one or more varying orders as applicable and in accordance with the present disclosure.

As can further be appreciated, the method of FIG. 3 may be scheduled to run at predetermined time intervals during operation of the vehicle 10 and/or may be scheduled to run based on predetermined events.

In one example, the method may begin at 100. In various embodiments, steps 110 and 120 are processed substantially simultaneously such that the sensor data 40, 46 from both sensor devices 22, 24 respectively can be aligned and compared for a given time period. For example, at 110, the external sensor device 22 monitors the scene external to the vehicle 10 and collects external sensor data 40. Likewise, at 120, the internal sensor device 24 monitors the driver and collects internal sensor data 46. The external sensor data 40 is processed to determine if an object is present at 130. If an object is not present at 140, the method continues with monitoring the scene at 110 and monitoring the driver at 120. If an object is detected at 140, the object map 42 is generated by mapping the object represented by the external sensor data 40 using the HUD map 44 at 150. The driver's gaze is determined from the internal sensor data 46 at 160. The gaze map 48 is generated by mapping the driver's gaze represented by the internal sensor data 40 using the HUD map 50 at 170.

Thereafter, the driver object detection analysis is performed by comparing the object map 42 with the gaze map 48 at 180. For example, if coordinates of the gaze map 48 overlap with coordinates of the object map 42, then the driver's gaze is in line with the object. If, however, the coordinates of the gaze map 48 do not overlap with coordinates of the object map 42, then the driver's gaze is not in line with the object.

It is then determined whether the driver is looking at the object based on the whether the driver's gaze is in line with the object. For example, it is concluded that the driver did not look at the object if the driver's gaze is not in line with the object. In another example, it is concluded that the driver did look at the object if the driver's gaze is in line with the object.

If, at 190, the driver did see the object, the object is not highlighted by the HUD system 20 and the method may continue with monitoring the sensor data 40, 46 at 110 and 120. If, however, at 190 the driver did not look at the object, the object is highlighted on by the HUD system 20 at 200. The object is optionally highlighted based on the object's threat status 54 using color and/or frequency.

At 210, warning signals 58 and/or controls signals 60 are generated to the other warning systems 26 and/or the collision avoidance systems 28 by coordinating the signals 58, 60 with the highlights in an attempt to alert the driver and/or avoid collision with the object. Thereafter, the method may continue with monitoring the sensor data 40, 46 at 110 and 120.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for detecting whether a driver of a vehicle detected an object outside of the vehicle, comprising:
receiving external sensor data that indicates a scene outside of the vehicle;
receiving internal sensor data that indicates an image of the driver;
determining whether the driver detected the object based on the external sensor data and the internal sensor data; and
selectively generating a control signal based on whether the driver detected the object.

2. The method of claim 1 further comprising mapping the external sensor data to coordinates of a heads up display, and wherein the determining whether the driver detected the object is based on the mapping.

3. The method of claim 2 further comprising determining where the object is located outside of the vehicle based on the external sensor data and wherein the mapping the external sensor data is based on the determining where the object is located.

4. The method of claim 1 further comprising mapping the internal sensor data to coordinates of a heads up display, and wherein the determining whether the driver detected the object is based on the mapping.

5. The method of claim 4 further comprising determining a gaze of the driver based on the internal sensor data and wherein the mapping the internal sensor data is based on the gaze of the driver.

6. The method of claim 1 further comprising:
mapping the external sensor data to coordinates of a heads up display;
mapping the internal sensor data to the coordinates of the heads up display; and
wherein the determining whether the driver detected the object is based on a comparison of the mapping of the external sensor data and the mapping of the internal sensor data.

7. The method of claim 1 wherein the control signal controls an image on a heads up display.

8. The method of claim 7 wherein the control signal controls a highlight of an image on the heads up display.

9. The method of claim 8 wherein the selectively generating the control signal is further based on a threat status of the object.

10. The method of claim 9 wherein the control signal controls at least one of a color and a frequency of the highlight based on the threat status.

11. The method of claim 1 wherein the control signal controls a vehicle warning system.

12. The method of claim 1 wherein the control signal controls a collision avoidance system.

13. The method of claim 1 further comprising selectively generating a second control signal based on the determining whether the driver detected the object, wherein the second control signal controls at least one of a vehicle warning system and a collision avoidance system.

14. A system for detecting whether a driver of a vehicle detected an object outside of the vehicle, comprising:
a first module that receives external sensor data that indicates a scene outside of the vehicle;
a second module that receives internal sensor data that indicates an image of the driver;
a third module that determines whether the driver detected the object based on the external sensor data and the internal sensor data; and
a fourth module that selectively generates a control signal based on whether the driver detected the object.

15. The system of claim 14 wherein the first module maps the external sensor data to coordinates of a heads up display, and determines whether the driver detected the object based on the mapping.

16. The system of claim 15 wherein the first module determines where the object is located outside of the vehicle based on the external sensor data and maps the external sensor data based on where the object is located.

17. The system of claim 14 wherein the second module maps the internal sensor data to coordinates of a heads up display, and determines whether the driver detected the object is based on the mapping.

18. The system of claim 17 wherein the second module determines a gaze of the driver based on the internal sensor data, and maps the internal sensor data based on the gaze of the driver.

19. The system of claim 14 wherein the control signal controls at least one of an image on a heads up display, a vehicle warning system, and a collision avoidance system.

20. The system of claim 19 wherein the control signal controls a highlight of an image on the heads up display.

21. The system of claim 19 wherein the fourth module selectively generates the control signal based on a threat status of the object.

22. The system of claim 21 wherein the control signal controls at least one of a color and a frequency of the image based on the threat status.

23. A vehicle, comprising:
a heads up display system; and
a heads up display control module that receives external sensor data that indicates a scene outside of the vehicle, that receives internal sensor data that indicates an image of a driver of the vehicle, that determines whether the driver detected the object based on the external sensor data and the internal sensor data, and that selectively generates a control signal to the heads up display system based on whether the driver detected the object.
